(19) United States
(12) Patent Application Publication
(10) Pub. No.: US 2019/0299838 A1
(43) Pub. Date: Oct. 3, 2019

(54) TANK ARRANGEMENT FOR A WATERJET TRUCK

(71) Applicant: NLB Corp., Wixom, MI (US)

(72) Inventors: Tim D. Heinonen, Linden, MI (US); David W. Mackie, Waterford, MI (US)

(21) Appl. No.: 15/943,924

(22) Filed: Apr. 3, 2018

(51) Int. Cl. B60P 3/22; E01H 1/10; B08B 3/02; B60P 3/24

(52) U.S. Cl. CPC B60P 3/2215; E01H 1/103; B60P 3/243; B60P 3/225; B08B 3/024

(57) ABSTRACT

An example fluid storage system for a mobile waterjet system comprises a first tank having a first side and a second side opposite the first side. A second tank abuts the first side, and a third tank abuts the second side.

### BACKGROUND

This application relates to a mobile high pressure water cleaning system, such as is known for cleaning highways or runways, wherein the system stores clean pump water and waste water.

High pressure water cleaning systems are known, and may include a movable platform carrying water jets that move along a surface to be cleaned, such as a runway or highway. Typically, a pump delivers extremely high pressure water to the surface. As an example, pressures of approximately 40,000 psi may be used. The water efficiently removes materials from the surface to be cleaned. A vacuum is also applied to the platform, and pulls the water and debris back onto the vehicle.

The water to be pumped is maintained in a clean water tank. The water pulled back onto the vehicle along with the removed material, is held in a waste water tank.

### SUMMARY

An example fluid storage system for a mobile waterjet system comprises a first tank having a first side and a second side opposite the first side. A second tank abuts the first side, and a third tank abuts the second side.

An example waterjet vehicle comprises a truck bed having a centerline extending in a first direction between a front end and a back end. A first tank is arranged on the truck bed along the centerline. A second tank and a third tank are arranged on the truck bed on either side of the centerline.

These and other features of the present invention can be best understood from the following specification and drawings, the following of which is a brief description.

### BRIEF DESCRIPTION OF THE DRAWINGS

The drawings can be briefly described as follows:

FIG. 1 illustrates an exemplary high pressure water cleaning system.

FIG. 2 schematically illustrates the water tank arrangement of the system of FIG. 1.

### DETAILED DESCRIPTION

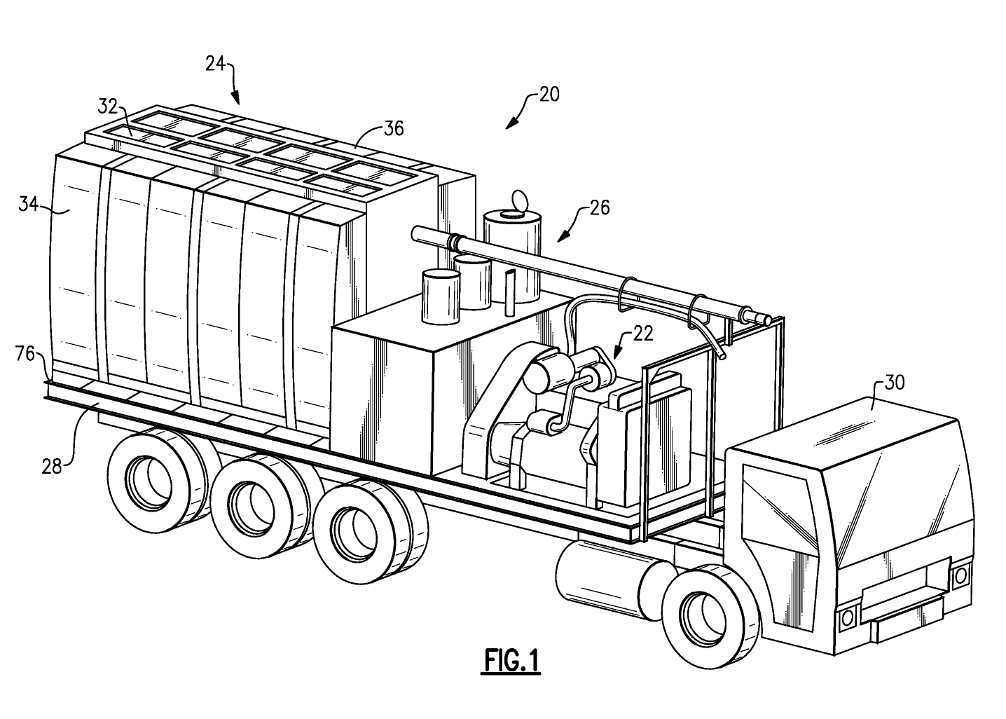

FIG. 1 illustrates an example mobile marking removal system 20. This example system 20 includes a high-pressure pump 22, a water tank portion 24, and a vacuum system 26 to recover water and debris. In this system 20, each of these components is carried on a vehicle 28. The vehicle 28 may be a truck with a truck cab 30, or other vehicle types, such as a tractor.

In the system 20, water or other fluid is stored in the water tank portion 24. During use, water is pulled from the water tank portion 24 and is delivered from the high pressure pump 22 to a surface to be cleaned, such as a roadway. The water that is delivered to the surface may have a pressure on the order of 40,000 psi. Other pressures, both higher and lower, may be used.

In the illustrated embodiment, the system 20 includes a vacuum system 26 that pulls water and debris from the surface back onto the vehicle 28. The vacuum system 26 may include a vacuum line, a vacuum basket, a vacuum power unit, a vacuum tank, a cartridge filter, and a vacuum pump. The vacuum pump is powerful enough to pull the waste water and removed debris back onto the vehicle 28 from the surface.

The water tank portion 24 has several separate water tanks to store clean water and waste water with debris. In the illustrated embodiment, the water tank portion 24 includes a first tank 32, a second tank 34, and a third tank 36. The first tank 32 is arranged in between the second and third tanks 34, 36. In this example, the first tank 32 holds waste water and debris that is pulled back onto the vehicle 28 by the vacuum system 26. The second and third tanks 34, 36 hold clean water to be delivered to the high pressure pump 22. The second and third tanks 34, 36 may be in fluid communication with one another in some examples. In another embodiment, the first tank 32 may hold clean water while the second and third tanks 34, 36 hold waste water.

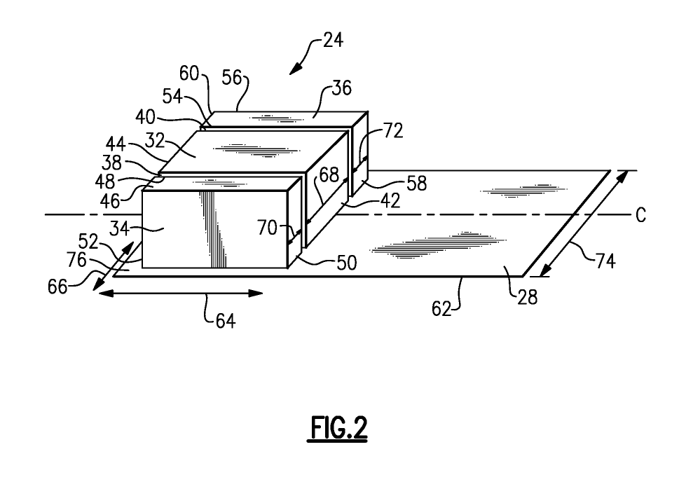

FIG. 2 is a highly schematic illustration of the arrangement of the water tank portion 24. The vehicle 28 has a truck bed with a frame 62, which defines a first direction 64 along a length of the vehicle 28 and a second direction 66 along a width of the vehicle 28. The first and second directions 64, 66 form a plane that is substantially parallel with the surface that the vehicle 28 is on, such as a road. Each of the first, second, and third tanks 32, 34, 36 is arranged in the same plane parallel with the surface. The vehicle 28 has a centerline C in the first direction 64. Each of the first, second, and third tanks 32, 34, 36 is generally rectangular with a length extending along the first direction 64 and a width along the second direction 66. The first tank 32 is arranged along the centerline C. In one example, the first tank 32 is symmetrical about a plane containing the centerline C.

The first tank 32 has a first side 38 opposite a second side 40, each of which face in the second direction 66. The first tank 32 further has a front end 42 opposite a back end 44, each of which face in the first direction 64. The second tank 34 has a first side 46 opposite a second side 48, and a front end 50 opposite a back end 52. The third tank 36 has a first side 54 opposite a second side 56, and a front end 58 opposite a back end 60. In an embodiment, the first side 38 of the first tank 32 abuts the second side 48 of the second tank 34. The second side 40 of the first tank 32 abuts the first side 54 of the third tank 36. Put another way, the first tank 32 is arranged in between the second tank 34 and the third tank 36, relative to the second direction 66. Note, in FIG. 2, the first, second, and third tanks 32, 34, 36 are shown spaced-apart from one another for illustration purposes, but in one example of this disclosure the first, second, and third tanks 32, 34, 36 abut and are in direct contact with one another.

In an embodiment, the back ends 44, 52, 60 of the tanks 32, 34, 36 are substantially aligned with one another. In a further embodiment, the front ends 42, 50, 58 of the tanks 32, 34, 36 are substantially aligned with one another.

In one embodiment, a width 68 of the first tank 32 is more than twice a width 70 of the second tank 34 or a width 72 of the third tank 36. In another embodiment, the width 68 is about equal to a sum of the width 70 and the width 72. The width 70 of the second tank 34 may be about the same as the width 72 of the third tank 36. A sum of the widths 68, 70, 72 of the first, second, and third tanks 32, 34, 36 is about equal to a width 74 of the frame 62. In an embodiment, the first, second, and third tanks 32, 34, 36 all have about the same length and height. The length of the first, second, and third tanks 32, 34, 36 may be larger than the width or height of the tanks 32, 34, 36.

In the illustrated embodiment, the water tank portion 24 is located at the back end of the vehicle 28. In this embodiment, the first, second, and third tanks 32, 34, 36 are located aft of the pump 22 and vacuum system 26. The back ends 44, 52, 60 of the tanks 32, 34, 36 may be substantially aligned with a back end 76 of the frame 62. In another embodiment, the water tank portion 24 may be located at the front end portion or in the middle of the vehicle. The first, second, and third tanks 32, 34, 36 are arranged on the vehicle 28 in the same position in the first direction 64.

Known systems that have a clean water tank in front of a dirty water tank result in a weight shift towards the back of the vehicle as the clean water tank is depleted and the waste water tank is filled. However, in the disclosed arrangement, the weight distribution of the truck remains consistent from the front to back of the vehicle, even when the clean water tank is depleted and the waste water tank is filled.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

1. A fluid storage system for a mobile waterjet system, comprising:
a first tank having a first side and a second side opposite the first side; and
a second tank and a third tank, wherein the second tank abuts the first side and the third tank abuts the second side.

2. The fluid storage system of claim 1, wherein the first, second, and third tanks are fluid storage tanks.

3. The fluid storage system of claim 2, wherein the first tank is configured to store waste water and the second and third tanks are configured to store clean water.

4. The fluid storage system of claim 1, wherein the first tank is about twice as large as the second or third tanks.

5. The fluid storage system of claim 1, wherein the first tank has a width that is about twice as large as a width of the second tank or a width of the third tank.

6. The fluid storage system of claim 1, wherein the first, second, and third tanks are mounted on a vehicle.

7. The fluid storage system of claim 6, wherein the vehicle is a waterjet truck.

8. The fluid storage system of claim 6, wherein the vehicle further comprises a vacuum system and a high pressure pump.

9. The fluid storage system of claim 8, wherein the first, second, and third tanks are positioned on the vehicle aft of the vacuum system and high pressure pump.

10. The fluid storage system of claim 1, wherein the first, second, and third tanks are all arranged in a horizontal plane parallel with a bed of the vehicle.

11. A waterjet vehicle, comprising:
a truck bed having a centerline extending in a first direction between a front end and a back end;
a first tank arranged on the truck bed along the centerline; and
a second tank and a third tank arranged on the truck bed on either side of the centerline.

12. The waterjet vehicle of claim 11, wherein a vacuum system and a high pressure pump are arranged on the truck bed.

13. The waterjet vehicle of claim 12, wherein the first, second, and third tanks are positioned on the truck bed aft of the vacuum system and high pressure pump.

14. The waterjet vehicle of claim 11, wherein the first, second, and third tanks are fluid storage tanks.

15. The waterjet vehicle of claim 14, wherein the first tank is configured to store waste water and the second and third tanks are configured to store clean water.

16. The waterjet vehicle of claim 11, wherein the second tank is positioned at a first edge of the truck bed, and the third tank is positioned at a second edge of the truck bed opposite the first edge.

17. The waterjet vehicle of claim 11, wherein the first, second, and third tanks each have a length along the first direction that is longer than a width or a height of each of the first, second, and third tanks.

18. The waterjet vehicle of claim 11, wherein a sum of a width of the first tank, a width of the second tank, and a width of the third tank is about the same as a width of the truck bed.

19. The waterjet vehicle of claim 11, wherein the first tank is about twice as large as the second or third tanks.

20. The waterjet vehicle of claim 11, wherein the first tank, second tank, and third tank are all arranged at a position in the first direction.
